(19) United States
(12) Patent Application Publication
(10) Pub. No.: US 2012/0139922 A1
(43) Pub. Date: Jun. 7, 2012

(54) SYSTEM FOR DISPLAYING FUEL EFFICIENCY OF VEHICLE ON TERMINAL AND METHOD THEREOF

(75) Inventor: Sung Wook HEO, Yongin (KR)

(73) Assignees: KIA MOTORS CORPORATION, Seoul (KR); HYUNDAI MOTOR COMPANY, Seoul (KR)

(21) Appl. No.: 13/172,535

(22) Filed: Jun. 29, 2011

(30) Foreign Application Priority Data
Dec. 6, 2010 (KR) 10-2010-0123835

(51) Int. Cl. G06T 11/20

(52) U.S. Cl. 345/440

(57) ABSTRACT

A system for displaying fuel efficiency of a vehicle on a terminal and a method thereof are provided. The system for displaying fuel efficiency on a terminal, includes: a vehicle terminal calculating average fuel efficiency of a vehicle using vehicle data; and a vehicle information center averaging average fuel efficiencies of respective vehicles of the same vehicle type when the average fuel efficiencies of a plurality of vehicles are received from respective vehicle terminals of the plurality of vehicles to calculate and transmit a reference average fuel efficiency to each of the respective vehicles, in which the vehicle terminals compare the average fuel efficiencies with the reference average fuel efficiency and display the comparison result on a screen, respectively.

### CROSS-REFERENCES TO RELATED APPLICATIONS

Priority to Korean patent application number 10-2010-0123835, filed on December 6, which is hereby incorporated by reference in its entirety, is claimed.

### BACKGROUND OF THE INVENTION

1. Field of the Invention

The present invention relates to a system for displaying fuel efficiency of a vehicle on a terminal and a method thereof, and more particularly, to a technology for comparing the average fuel efficiency of a driver's vehicle with average fuel efficiencies of other drivers having the same vehicle type where the result of the comparison is displayed on the terminal accordingly.

2. Description of the Related Art

A person's driving habits and the road environments in which a vehicle is driven significantly affect fuel efficiency of a vehicle. In particular, since driving habits account for one of the major reasons for a in a vehicles fuel efficiency from vehicle to the next, it is important for a driver to make an effort to recognize when his or her driving habits are greatly affecting the fuel efficiency of the vehicle.

As disclosed in Korean Laid-Open Utility Model Publication No. 20-1999-0020953, systems have been developed to automatically calculate and display an average fuel efficiency of a vehicle by utilizing the amount fuel used and the travel distance of the driver's vehicle. However, in the related art, there are no comparisons with other driver's vehicles/targets that have similar types of vehicles. Thus, the driver has no way of knowing if he or she is getting the best fuel efficiency possible for that particular vehicle type, and has no way of knowing whether or not they need to adjust their driving habits in order to achieve better fuel efficiency.

### SUMMARY OF THE INVENTION

The present invention provides a system for displaying fuel efficiency of a vehicle on a terminal that allows a driver to objectively recognize whether the driver is achieving the best average fuel efficiency of a particular vehicle type by providing a system which averages fuel efficiencies of other drivers for the same vehicle type, outputs a reference average fuel efficiency for that vehicle type, and compares and displays the reference average fuel efficiency for that vehicle type along with average fuel efficiency of that driver's vehicle, and a method thereof.

In one embodiment of the present invention, a system for displaying fuel efficiency on a terminal may include a vehicle terminal and a vehicle information center. More specifically, the vehicle terminal calculates the average fuel efficiency of a vehicle using vehicle data. The vehicle information center, on the other hand, averages a collection of average fuel efficiencies of respective vehicles of the same vehicle type. This collection of average fuel efficiencies is compiled by storing each vehicle's fuel efficiency at the vehicle information center when the vehicle information center receives a request from the respective vehicle terminals of a plurality of other vehicles to calculate the average fuel efficiency for that vehicle type. The vehicle information center then transmits a reference average fuel efficiency to each of the respective vehicles. Upon receiving this reference average fuel efficiency, the vehicle terminals compare the average fuel efficiencies with the reference average fuel efficiency and display the comparison result on a screen, accordingly.

In some embodiments of the present invention, the vehicle terminal periodically transmits the average fuel efficiency of the vehicle to the vehicle information center. The vehicle information center then compares the average fuel efficiencies of respective vehicles with the reference average fuel efficiency, in order to calculate the average fuel efficiency for that particular vehicle type, and transmits a reference fuel efficiency value by vehicle type to respective vehicles of that same type. The reference fuel efficiency value correlates to a ranking of fuel efficiency for that particular vehicle/driver in relation to other driver's vehicles of that same vehicle type, which have also been received and calculated by the vehicle information center.

The vehicle terminal may also include a wireless communication unit, a storage unit, an eco-switch, a display unit and a control unit. The wireless communication unit may be configured to perform wireless communication with the vehicle information center and the storage unit may be configured to store the average fuel efficiency, the reference average fuel efficiency and the fuel efficiency point/value described above. Furthermore, the eco-coach switch may be turned-on/off by a user and the display unit displays the average fuel efficiency, the reference average fuel efficiency, and the fuel efficiency point/value on a screen within each vehicle. The control unit calculates the average fuel efficiency of that particular vehicle using that vehicle's data, and controls the display unit to display the average fuel efficiency, the reference average fuel efficiency, and the fuel efficiency point/value, e.g., when the eco-coach switch is turned-on by the user.

The vehicle terminal may display the average fuel efficiency based on the reference average fuel efficiency plotted on a grouped-column graph. The vehicle information center then transfers the reference average fuel efficiency and the fuel efficiency points/values by vehicles to drivers of the respective vehicles using either an electronic mail, a web page, a phone, or characters.

In accordance with another aspect of the present invention, a method for displaying fuel efficiency on a terminal.

Methodologically, the present invention first calculates the average fuel efficiency of a specific vehicle using vehicle data provided to a vehicle terminal. The average fuel efficiencies of multiple vehicles of the same vehicle type are then averaged on a vehicle information center to calculate and transmit a reference average fuel efficiency to the vehicle terminal of the respective vehicles. The vehicle terminal then compares the average fuel efficiencies with the reference average fuel efficiency and displays the comparison result on a screen within that specific vehicle.

Additionally, in some embodiments of the present invention, the terminal may also periodically transmit the average fuel efficiency of its associated vehicle to the vehicle information center.

As noted above, to the vehicle information center may also be configured to calculate and transmit a fuel efficiency value for each specific vehicle to the terminal within that specific vehicle.

More specifically, the comparison results may be displayed as a grouped-column graph on a screen within each vehicle, respectively. In some embodiments of the present invention, the average fuel efficiency may be displays as a green grouped-column graph when the average fuel efficiency is equal to or greater than the reference average fuel efficiency by a first reference value, displayed as a yellow grouped-column graph when the average fuel efficiency is less than or equal to the first reference value and equal to or greater than the reference average fuel efficiency by a second reference value, and displayed as a red grouped-column graph when the average fuel efficiency is less than the reference average fuel efficiency by the second reference value. Each vehicle's fuel efficiency points/values may then be ranked among the average fuel efficiencies for that type of vehicle.

The vehicle information center may then transfer the reference average fuel efficiency and the fuel efficiency points/values by vehicle to drivers of the respective vehicles using either electronic mail, a web page, a phone, or characters.

In some embodiments of the present invention, the vehicle information center may transmit the reference average fuel efficiency and a fuel efficiency point/value of that specific vehicle to the vehicle at least once when power of the vehicle is turned-on to achieve a communication connection between the vehicle terminal and the vehicle information center.

Advantageously, the present invention allows a driver to objectively recognize whether their driving habits are adversely affecting the fuel efficiency of their vehicle and accordingly adjust their driving habit. That is, the driver can review their fuel efficiency in relation to other drivers of the same vehicle type by comparing and displaying the average fuel efficiency of a driver with the average fuel efficiency of other drivers for the same vehicle type.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a system for displaying fuel efficiency of a vehicle on a terminal according to an exemplary embodiment of the present invention;

FIG. 2 is a flowchart illustrating a method for displaying fuel efficiency of a vehicle on a terminal according to an exemplary embodiment of the present invention; and

FIG. 3 is a view illustrating an example of a vehicle fuel efficiency information display screen of FIG. 2.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

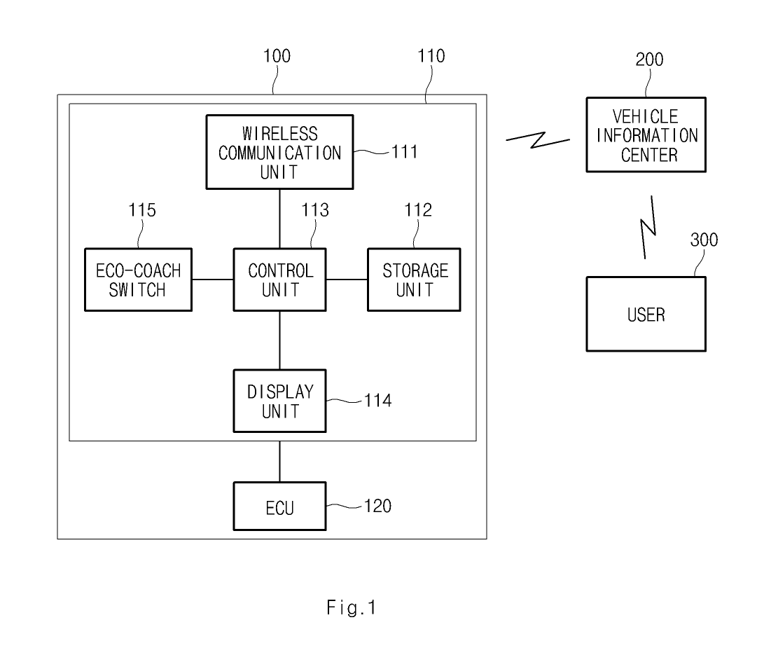

A system for displaying fuel efficiency of a vehicle on a terminal and a method thereof according to an exemplary embodiment of the present invention will be explained with reference to FIGS. 1-3 in detail.

FIG. 1 is a block diagram illustrating a configuration of a system for displaying fuel efficiency of a vehicle on a terminal according to an exemplary embodiment of the present invention.

The system for displaying fuel efficiency of a vehicle on a terminal according to an exemplary embodiment of the present invention includes a vehicle 100 having a vehicle terminal 110 and an electronic Control Unit (ECU) 120, and a vehicle information center 200.

The vehicle terminal 110 includes a wireless communication unit 111, a storage unit 112, a control unit 113, a display unit 114, and an eco-coach switch 115.

The wireless communication unit 111 performs wireless communication with the vehicle information center 200.

The storage unit 112 stores vehicle data and average fuel efficiency at predetermined time intervals (e.g., 2.5 minutes) when the vehicle data is received from the ECU 120, and a reference average fuel efficiency and a fuel efficiency point/value that is received from the vehicle information center 200.

In some embodiments of the present invention, the storage unit 112 simultaneously records a storage date and time at when storing the data and removes oldest stored information one at the time when addition of new data would exceed the maximum capacity of the storage unit.

The control unit 113 calculates average fuel efficiency using vehicle data that has been received from the ECU 120. The control unit 113 also checks an on/off status of the eco-coach switch 115 which may be turned on or off by a user. When the eco-coach switch 115 is turned-on, the control unit 113 controls the display unit 114 to display an average fuel efficiency of the corresponding vehicle, and an reference average fuel efficiency and fuel efficiency point/value of other vehicles having the same vehicle type.

The display unit 114 displays the average fuel efficiency of that specific vehicle, and the reference average fuel efficiency and fuel efficiency point/value of the same vehicle type, e.g., as numerals or grouped-column graphs.

The ECU 120 collects vehicle data such as vehicle speed information, travel distance, and/or fuel consumption amount from respective controllers (e.g., a transmission controller and a engine controller) and transfers the collected vehicle data to the vehicle terminal 110. Operationally, the ECU 120 starts to collect vehicle data from the moment it is powered-on and continuously collects the vehicle until powered-off.

Meanwhile, when the vehicle information center 200 receives the average fuel efficiency of a corresponding vehicle from multiple vehicles, it calculates and transmits a reference average fuel efficiency and a fuel efficiency point/value related to the same vehicle type to each corresponding vehicle. The fuel efficiency point/value means a point/value (order) according to a ratio of average fuel efficiency of a driver's vehicle to the reference average fuel efficiency of the same vehicle type calculated at the vehicle information center. Moreover, the vehicle information center 200 may also directly provide average fuel efficiency of a corresponding vehicle, average fuel efficiency and a fuel efficiency point/value of the same vehicle type to a user via a web page, an electronic mail, a phone, or a short message service (SMS).

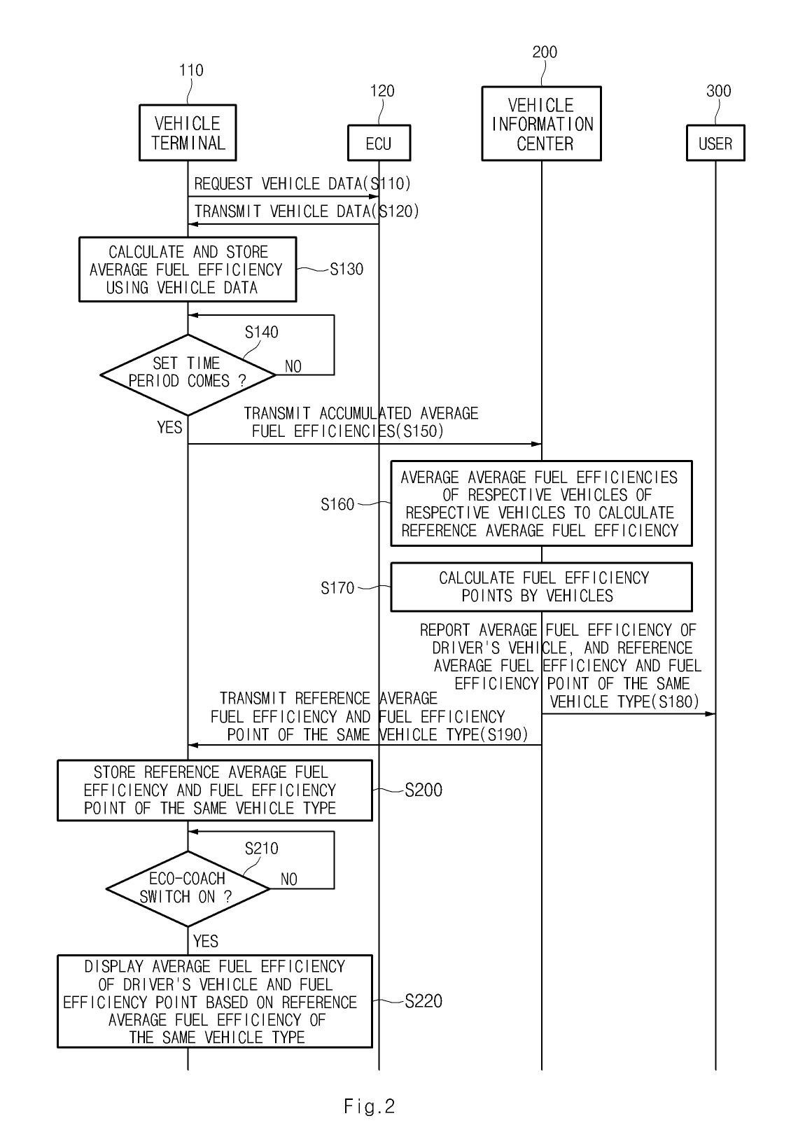

A method for displaying fuel efficiency of a vehicle on a terminal according to an exemplary embodiment of the present invention will be explained with reference to FIG. 2 in detail.

First, when a vehicle is turned-on, a control unit 113 of a vehicle terminal 110 requests vehicle data from an ECU 120 (S110). Accordingly, the ECU 120 transmits the requested vehicle data collected from respective controllers to the vehicle terminal 110 (S120).

Next, the vehicle terminal 110 calculates average fuel efficiency using the vehicle data received from the ECU 120 and stores the calculated average fuel efficiency in a storage unit 112 (S130). In some embodiments, the average fuel efficiency may be periodically calculated and stored at about 2.5 minute interval together with the associated date and time.

Subsequently, the control unit 113 of the vehicle terminal 110 checks whether a set time comes (S140). When the set time comes, the control unit 113 transmits accumulated average fuel efficiencies to the vehicle information center 200 (S150). For example, the time-period may be set to a designated date such as once a month or two months.

Next, the vehicle information center 200 averages average fuel efficiencies of respective vehicles received from each respective vehicle to calculate a reference average fuel efficiency (S160). Accordingly, the vehicle information center 200 periodically receives average fuel efficiency of respective vehicles from a plurality of vehicles. In this case, respective periods may be changed according to each vehicle specifically. For example, the vehicle terminal 110 may transmit vehicle data to the vehicle information center 200 according to a period of time (e.g., once a month or a week) which has been previously determined by a driver/user so that the vehicle information center 200 may use the vehicle data to calculate a reference average fuel efficiency for that respective vehicle type.

In addition, the vehicle information center 200 may compare average fuel efficiencies of vehicles with the reference average fuel efficiency to calculate fuel efficiency points/values of vehicles (S170). In this case, fuel efficiency points/values mean a specific vehicle's ranking or rating in relation to the average fuel efficiency of vehicles of the same type.

For example, when average fuel efficiency of client A is 25 MPG, average fuel efficiency of client B is 24 MPG, the average fuel efficiency of client C is 22 MPG, and the average fuel efficiency of client E is 20 MPG all having the same vehicle type, the clients A, B, C, D, and E are displayed as first, second, third, fourth, and fifth respectively.

Subsequently, the vehicle information center 200 may also report the average fuel efficiency of a driver's vehicle, and a reference average fuel efficiency and the fuel efficiency point/value of that vehicle in relation to other vehicles of the same vehicle type to a user via either a web page, electronic mail, a phone, SMS, or MMS (S180), and transmit the reference average fuel efficiency and the fuel efficiency point/value of the same vehicle type to the vehicle terminal 110 (S190).

Additionally, the information center 200 may also report average fuel efficiency of a driver's vehicle and reference average fuel efficiency and the fuel efficiency point/value to a user at specific time intervals, e.g., a specific date or time) which may be previously determined by the driver/user. Moreover, the vehicle information center 200 may provide the reference average fuel efficiency and the fuel efficiency point to a vehicle once when vehicle is turned-on and connection with a vehicle terminal 110 is achieved.

Next, the vehicle terminal 110 stores the reference average fuel efficiency and the fuel efficiency point of the same vehicle type received from the vehicle information center 200 (S200), and the control unit 113 checks the on/off status of the eco-coach switch 115 (S210).

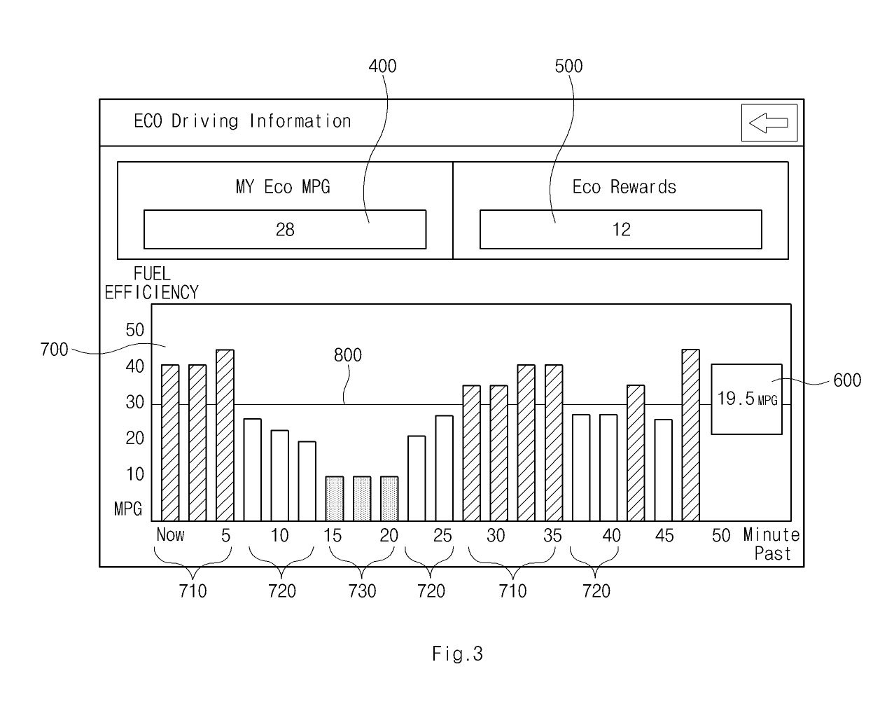

When the eco-coach switch 115 is turned-on, as shown in FIG. 3, the control unit 113 displays the average fuel efficiency of a driver's vehicle based on the reference average fuel efficiency 600 of the same vehicle type on a screen with a grouped-column graph 700, and displays a fuel efficiency point/value 500 on the screen via, e.g., numerals (S220).

In the illustrative embodiment of the present invention, when a grouped-column graph indicating the average fuel efficiency of a driver's vehicle is that vehicles average fuel efficiency for, e.g., 2.5 minutes and average fuel efficiency of the driver's vehicle is equal to or greater than e.g., 20% of the reference average fuel efficiency 600, it may be displayed as a green grouped-column graph 710. When the average fuel efficiency of the driver's vehicle ranges from, e.g., −20 to +20% of the reference average fuel efficiency 600, it may be displayed with a yellow grouped-column graph 720. When the average fuel efficiency of the driver's vehicle is less than −20% of the reference average fuel efficiency 600, it may be displayed with a red grouped-column graph 720.

Consequently, when the grouped-column graph is a green one, it may be determined that a driver has a better driving habit than other driver's having the same vehicle type, thus resulting in a better fuel efficiency than other drivers. When the grouped-column graph is a yellow one, it may be determined that a driver drives a vehicle in a manner which results in a fuel efficiency which is about average in relation to other driver's of the same vehicle type. When the grouped-column graph is a red one, it may be determined that a driver drives a vehicle in a manner which results in a worse fuel efficiency in comparison with other drivers of the same vehicle type.

In some embodiments of the present invention, when the number of stored grouped-column graphs of FIG. 3 is, e.g., less than twenty, each column may be sequentially displayed in a rightwardly direction from the left hand side, where the furthest right is the oldest and the furthers left is the newest.

Notably, when the eco-coach switch 115 is turned-on in a state that the vehicle terminal 110 cannot communicate with the vehicle information center 200, it displays only average fuel efficiency of a driver's vehicle on a screen.

As is apparent from the above description, in the present invention, a vehicle information center periodically receives and averages average fuel efficiencies of respective vehicles received from vehicle terminals of a plurality of vehicles to calculate and transmit a reference average fuel efficiency for the same vehicle type to respective vehicles. Accordingly, respective vehicles may compare its average fuel efficiencies with the reference average fuel efficiency and display the comparison result so that a driver may visually assess their fuel efficiency due to driving habits and make an effort to increase their fuel efficiency accordingly.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A system for displaying fuel efficiency on a terminal, comprising:
a vehicle terminal calculating average fuel efficiency of a vehicle using vehicle data; and
a vehicle information center averaging average fuel efficiencies of respective vehicles of the same vehicle type when the average fuel efficiencies of a plurality of vehicles which is received from each vehicle's respective vehicle terminal to calculate and transmit a reference average fuel efficiency to each respective vehicles,
wherein the vehicle terminal compares the average fuel efficiency with the reference average fuel efficiency and displays the comparison result on a screen.

2. The system of claim 1, wherein the vehicle terminal periodically transmits the average fuel efficiency of the vehicle to the vehicle information center.

3. The system of claim 1, wherein the vehicle information center compares the average fuel efficiencies of respective vehicles with the reference average fuel efficiency to calculate and transmit fuel efficiency points by vehicle to each respective vehicle.

4. The system of claim 3, wherein the fuel efficiency point by vehicle is a ranking of a vehicle's average fuel efficiency in relation to other vehicles' fuel efficiencies of the same vehicle type.

5. The system of claim 3, wherein the vehicle terminal comprises:
a wireless communication unit performing wireless communication with the vehicle information center;
a storage unit storing the average fuel efficiency, the reference average fuel efficiency and the fuel efficiency point;
an eco-coach switch turned-on/off by a user;
a display unit displaying the average fuel efficiency, the reference average fuel efficiency, and the fuel efficiency point on a screen; and
a control unit calculating the average fuel efficiency using the vehicle data, and controlling the display unit to display the average fuel efficiency, the reference average fuel efficiency, and the fuel efficiency point when the eco-coach switch is turned-on.

6. The system of claim 4, wherein the vehicle terminal comprises:
a wireless communication unit performing wireless communication with the vehicle information center;
a storage unit storing the average fuel efficiency, the reference average fuel efficiency and the fuel efficiency point;
an eco-coach switch turned-on/off by a user;
a display unit displaying the average fuel efficiency, the reference average fuel efficiency, and the fuel efficiency point on a screen; and
a control unit calculating the average fuel efficiency using the vehicle data, and controlling the display unit to display the average fuel efficiency, the reference average fuel efficiency, and the fuel efficiency point when the eco-coach switch is turned-on.

7. The system of claim 1, wherein the vehicle terminal displays the average fuel efficiency based on the reference average fuel efficiency via a grouped-column graph.

8. The system of claim 2, wherein the vehicle terminal displays the average fuel efficiency based on the reference average fuel efficiency via a grouped-column graph.

9. The system of claim 3, wherein the vehicle information center transfers the reference average fuel efficiency and the fuel efficiency points by vehicles to drivers of the respective vehicles using one of a group consisting of an electronic mail, a web page, a phone, or characters.

10. A method for displaying fuel efficiency on a terminal, comprising:
calculating, by a vehicle terminal, an average fuel efficiency of a vehicle using vehicle data;
averaging, by a vehicle information center, average fuel efficiencies of a plurality of vehicles of the same vehicle type to calculate and transmit a reference average fuel efficiency to the vehicle terminal of each of the respective vehicles; and
comparing, by each vehicle of the plurality of vehicles, the vehicle's average fuel efficiency with the reference average fuel efficiency and displaying the comparison result on a screen by the vehicle terminal on each of the respective vehicles.

11. The method of claim 10, further comprising: periodically transmitting the average fuel efficiency of the vehicle to the vehicle information center.

12. The method of claim 10, wherein transmitting reference average fuel efficiency to the respective vehicles allows the vehicle information center to compare the average fuel efficiencies of respective vehicles with the reference average fuel efficiency and calculate and transmit fuel efficiency points by vehicles to each vehicle respectively.

13. The method of claim 10, wherein displaying the comparison result further comprises displaying the average fuel efficiency based on the reference average fuel efficiency with a grouped-column graph.

14. The method of claim 13, wherein displaying the comparison result on a screen further comprises:
displaying the average fuel efficiency with a green grouped-column graph when the average fuel efficiency is equal to or greater than the reference average fuel efficiency by a first reference value;
displaying the average fuel efficiency with a yellow grouped-column graph when the average fuel efficiency is less than or equal to and equal to or greater than the reference average fuel efficiency by the first reference value and a second reference value, respectively; and
displaying the average fuel efficiency with a red grouped-column graph when the average fuel efficiency is less than the reference average fuel efficiency by the second reference value.

15. The method of claim 12, wherein each of the fuel efficiency points by vehicles is a ranking of a vehicle's average fuel efficiency in relation to other vehicles' fuel efficiencies of the same vehicle type.

16. The method of claim 10, wherein the vehicle information center further transfers the reference average fuel efficiency and the fuel efficiency points by vehicles to drivers of the respective vehicles using one of a group consisting of an electronic mail, a web page, a phone, or characters.

17. The method of claim 11, wherein the vehicle information center further transfers the reference average fuel efficiency and the fuel efficiency points by vehicles to drivers of the respective vehicles using one of a group consisting of an electronic mail, a web page, a phone, or characters.

18. The method of claim 10, wherein the vehicle information center transmits the reference average fuel efficiency and a fuel efficiency point of the vehicle to the vehicle at least once when power of the vehicle is turned-on to achieve communication connection between the vehicle terminal and the vehicle information center.

19. A system for displaying fuel efficiency on a terminal, comprising:
a vehicle terminal configured to calculate an average fuel efficiency of a vehicle using vehicle data; and
a vehicle information center configured to average a plurality of average fuel efficiencies of respective vehicles of the same vehicle type, the plurality of average fuel efficiencies received from a plurality of vehicles at the vehicle information center to calculate and transmit a reference average fuel efficiency to each of the respective vehicles,
wherein the vehicle terminal compares the average fuel efficiency with the reference average fuel efficiency and displays the comparison result on a screen.
